(19) United States
(12) Patent Application Publication
(10) Pub. No.: US 2015/0095414 A1
(43) Pub. Date: Apr. 2, 2015

(54) Event Scene Identification in Group Event

(71) Applicant: F-Secure Corporation, Helsinki (FI)

(72) Inventor: Pavel TURBIN, Fremont, CA (US)

(73) Assignee: F-Secure Corporation, Helsinki (FI)

(21) Appl. No.: 14/039,060

(22) Filed: Sep. 27, 2013

(51) Int. Cl. H04L 29/08

(52) U.S. Cl. CPC H04L 67/18; H04L 67/22
USPC 709/204

(57) ABSTRACT

There are provided measures for enabling event scene identification in a group event, in particular in a content storing and sharing service with a central storage. Such measures could exemplarily comprise tracking a rate of submissions for a group event from one or more agent devices of participants in the group event to a central storage, the submission from an agent device including content data relating to an event scene in the group event, detecting a time period of the event scene in the group event on the basis of the tracked rate of submissions for the group event, and detecting the location of the event scene in the group event on the basis of meta data for the content data of the submissions, said meta data relating at least to a location of the event scene in the group event.

### FIELD

The present invention relates to event scene identification in a group event. More specifically, the present invention relates to measures (including methods, apparatuses and computer program products) for enabling event scene identification in group event, in particular in a content storing and sharing service with a central storage.

### BACKGROUND

In recent years, cloud computing has increasingly emerged. This involves content storing and sharing services with a central storage implemented by cloud computing equipment. Using such content storing and sharing services, users can save and organize their content such as images, videos, music, documents, or the like in a central storage location, and users can access and share their content across all of their (network-enabled) devices such as their desktop computers and mobile devices including cellular phones, tablet computers, personal digital assistants (PDA), or the like.

At the same time, there has increasingly emerged a trend of sharing one's own content with other users such as friends, colleagues, or the like. Such content sharing functionality can also be realized by way of content storing and sharing services with a central storage implemented by cloud computing equipment, especially when all of the involved users are subscribed to a common service or application.

For example, various users participating in a group event could utilize such content storing and sharing service to exchange information relating to the commonly participated group event. Such group event may be any event or activity in which multiple users (with a common interest or background) participate, such as for example a company offsite activity, a wedding, a sport event, a street festival in a local community, or the like. During the group event, the participants typically tend to generate and share various contents relating to their current activities within the group event. For example, the participants take photos or videos, write instant messages (including tweets, etc.), or the like, and upload submissions with respective content data and, optionally, corresponding meta data to a central storage of their subscribed content storing and sharing service.

While a typical group event area is not very large, the participants are unable to be aware of any scenes, incidents or actions happing in the context of the group event (hereinafter referred to as event scenes). This unawareness may be due to the size of the group event area, the multitude of concurrently happening event scenes, the attendance of another event scene at that time, or the like. Anyway, a participant in the group event may want to attend or join certain event scenes which could be specifically interesting, important or relevant to him/her, but he/she is not aware of. For example, it may be desirable for a participant to attend or join a toast in a wedding, a particularly interesting tennis match in a large tennis tournament, a particularly impressive or popular performance on a cruise ship, a star appearing at a street festival, or the like. As event scenes are located at a specific location (which may be a single site within the group event area) and take only a limited time, there is the possibility that a participant misses actually interesting, important or relevant event scenes.

Accordingly, there is a demand that a participant in a group event could recognize a specific event scene in a group event, which is of a certain interest, importance or relevance to him/her. In view of the trend of the (real-time) usage of a content storing and sharing service by participants of a group event, there is a demand to enable identification of a specific event scene by utilizing the submissions of participants of the group event to the content storing and sharing service.

### SUMMARY

Various exemplifying embodiments of the present invention aim at addressing at least part of the above issues and/or problems.

Various aspects of exemplifying embodiments of the present invention are set out in the appended claims.

According to an example aspect of the present invention, there is provided a method, comprising tracking a rate of submissions for a group event from one or more agent devices of participants in the group event to a central storage, the submission from an agent device including content data relating to an event scene in the group event, detecting a time period of the event scene in the group event on the basis of the tracked rate of submissions for the group event, and detecting the location of the event scene in the group event on the basis of meta data for the content data of the submissions, said meta data relating at least to a location of the event scene in the group event.

According to an example aspect of the present invention, there is provided an apparatus, comprising a memory configured to store computer program code, and a processor configured to read and execute computer program code stored in the memory, wherein the processor is configured to cause the apparatus to perform: tracking a rate of submissions for a group event from one or more agent devices of participants in the group event to a central storage, the submission from an agent device including content data relating to an event scene in the group event, detecting a time period of the event scene in the group event on the basis of the tracked rate of submissions for the group event, and detecting the location of the event scene in the group event on the basis of meta data for the content data of the submissions, said meta data relating at least to a location of the event scene in the group event.

According to an example aspect of the present invention, there is provided an apparatus comprising means for tracking a rate of submissions for a group event from one or more agent devices of participants in the group event to a central storage, the submission from an agent device including content data relating to an event scene in the group event, means for detecting a time period of the event scene in the group event on the basis of the tracked rate of submissions for the group event, and means for detecting the location of the event scene in the group event on the basis of meta data for the content data of the submissions, said meta data relating at least to a location of the event scene in the group event.

According to an example aspect of the present invention, there is provided a computer program product comprising computer-executable computer program code which, when the program code is executed (or run) on a computer or the program is run on a computer (e.g. a computer of an apparatus according to any one of the aforementioned apparatus-related example aspects of the present invention), is configured to cause the computer to carry out the method according to the aforementioned method-related example aspect of the present invention.

The computer program product may comprise or may be embodied as a (tangible) computer-readable (storage) medium or the like, on which the computer-executable computer program code is stored, and/or the program is directly loadable into an internal memory of the computer or a processor thereof.

Further developments and/or modifications of the aforementioned example aspects of the present invention are set out herein with reference to the drawings and exemplifying embodiments of the present invention.

By way of exemplifying embodiments of the present invention, identification of a specific event scene in a group event is enabled by utilizing the submissions of participants of the group event to a content storing and sharing service with a central storage.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating a system arrangement according to exemplifying embodiments of the present invention,

FIG. 2 shows a flowchart illustrating a first example of a method according to exemplifying embodiments of the present invention,

FIG. 3 shows a flowchart illustrating a second example of a method according to exemplifying embodiments of the present invention,

FIG. 4 shows a graph illustrating a curve of a rate of submissions for explaining the detection of a time period of an event scene according to exemplifying embodiments of the present invention,

FIG. 5 shows a schematic diagram illustrating location-related relationships between various devices for explaining the detection of a location of an event scene according to exemplifying embodiments of the present invention,

FIG. 6 shows a diagram illustrating a first example of a procedure according to exemplifying embodiments of the present invention,

FIG. 7 shows a diagram illustrating a second example of a procedure according to exemplifying embodiments of the present invention,

FIG. 8 shows a diagram illustrating a third example of a procedure according to exemplifying embodiments of the present invention,

FIG. 9 shows a schematic diagram illustrating an example of a structure of apparatuses according to exemplifying embodiments of the present invention, and

FIG. 10 shows a schematic diagram illustrating another example of a structure of apparatuses according to exemplifying embodiments of the present invention.

### DETAILED DESCRIPTION OF DRAWINGS AND EMBODIMENTS

The present invention is described herein with reference to particular non-limiting examples and to what are presently considered to be conceivable embodiments of the present invention. A person skilled in the art will appreciate that the present invention is by no means limited to these examples, and may be more broadly applied.

Hereinafter, various exemplifying embodiments and implementations of the present invention and its aspects are described using several variants and/or alternatives. It is generally noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown.

According to exemplifying embodiments of the present invention, in general terms, there are provided measures and mechanisms for enabling event scene identification in group event, in particular in a content storing and sharing service with a central storage.

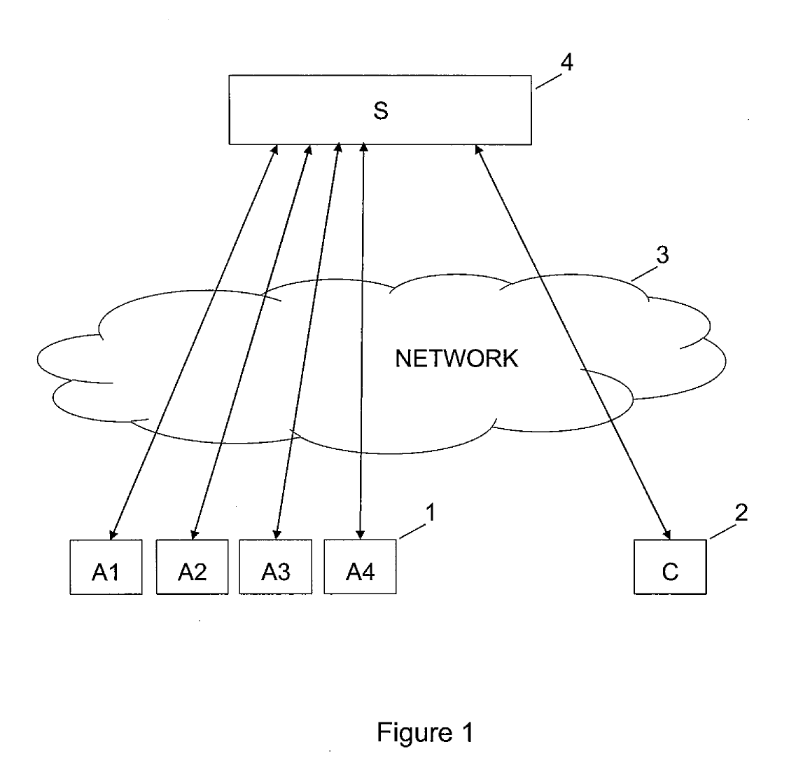

FIG. 1 shows a schematic diagram illustrating a system arrangement according to exemplifying embodiments of the present invention.

As shown in FIG. 1, exemplifying embodiments of the present invention are based on a system arrangement in which a certain number of devices 1, 2 are connected to a server 4 via a network 3. It is assumed that the devices 1 represent agent devices of participants in a group event, i.e. devices of group event participants that are subscribed to a content storing and sharing service and make submissions to the server 4 via the content storing and sharing service, and that the device 2 represents a client device of a participant in the group event, i.e. a device of a group event participant that is subscribed to the content storing and sharing service but does not make any submission to but retrieves information from the server 4 via the content storing and sharing service. For example, the users of the devices 1 may include professional and/or amateur photographers, twitter reports, or the like, and the user of the device 2 may include a normal guest of the group event. Any one of the devices 1, 2 may be realized/implemented by any kind of desktop or mobile computing equipment. Further, it is assumed that the server 4 represents a central storage or storage location of the content storing and sharing service, to which the users of the devices 1, 2 are subscribed. The server 4 may represent a backend of the content storing and sharing service or system, and may be realized/implemented by any kind of cloud computing equipment. Still further, it may be assumed that the network 3 may represent the Internet, an intranet or any other kind of wireless or wired communication network.

For implementing such content storing and sharing service, a corresponding application may be installed and executed on any one of the involved entities, e.g. agent devices 1, client device 2 and server 4. Such application should be capable of handling group events, i.e. the management of multiple users/devices in a common content storing and sharing domain.

For example, such application could be the YOUNITED™ application by F-Secure Corporation.

It is noted that the number of respective elements shown in FIG. 1 is for illustrative purposes only and does not limit the present invention. For example, another number of (more or less than four) agent devices may be involved in making submissions to the server, another number of (more than one) server may be involved in storing such submissions from the agent devices, and/or another number of (more than one) client device may be involved in retrieving information from the server.

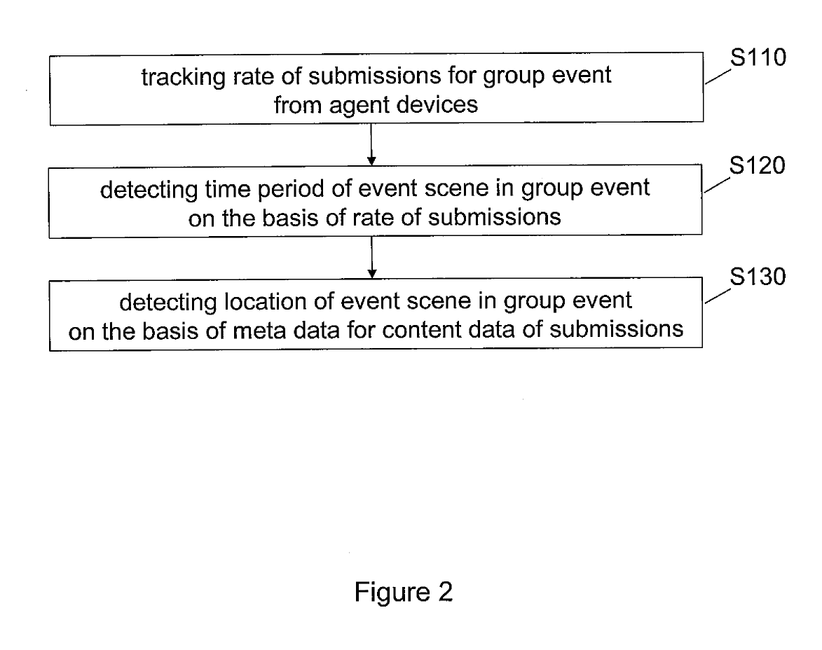

FIG. 2 shows a flowchart illustrating a first example of a method according to exemplifying embodiments of the present invention. The thus illustrated method may be operable at or by a server/central storage and/or a client device, as described in connection with FIG. 1.

As shown in FIG. 2, a method according to an exemplifying embodiment of the present invention comprises an operation (S110) of tracking a rate of submissions (i.e. a rate of submission uploads) for a group event from one or more agent devices of participants in the group event to a central storage, an operation (S120) of detecting a time period of the event scene in the group event on the basis of the tracked rate of submissions for the group event, and an operation (S130) of detecting the location of the event scene in the group event on the basis of meta data of the submissions (i.e. meta data for content data of the submissions). By way of the thus detected time period and location, the event scene may be recognized/identified (when still being in progress).

In the present example, it is assumed that a submission from an agent device includes content data relating to an event scene in the group event and meta data for the content data of the submission, wherein such meta data relate at least to a location of the event scene in the group event (to which the content data of the submission relate as well). In such case, all agent devices are enabled to and provide additional information on its provided content data (e.g. upon processing the same).

The meta data related to the location of the event scene in the group event may include latitude and longitude information. The meta data may also include the time of recording of the location information and a reference time zone of the time of recording. The meta data related to the location may include a global positioning system (GPS) coordinates identifying the location. The GPS coordinates can include a GPS time at which the GPS coordinates were recorded. The location information may be determined, for example, based on multilateration of the detected radio signals between radio towers of the network and the agent device. Also any other positioning system information may be included with the meta data related to the location of the event scene, such as any indoor positioning system information and location information generated by using magnetic variation techniques (agent devices sensing and recording Earth's magnetic field variation).

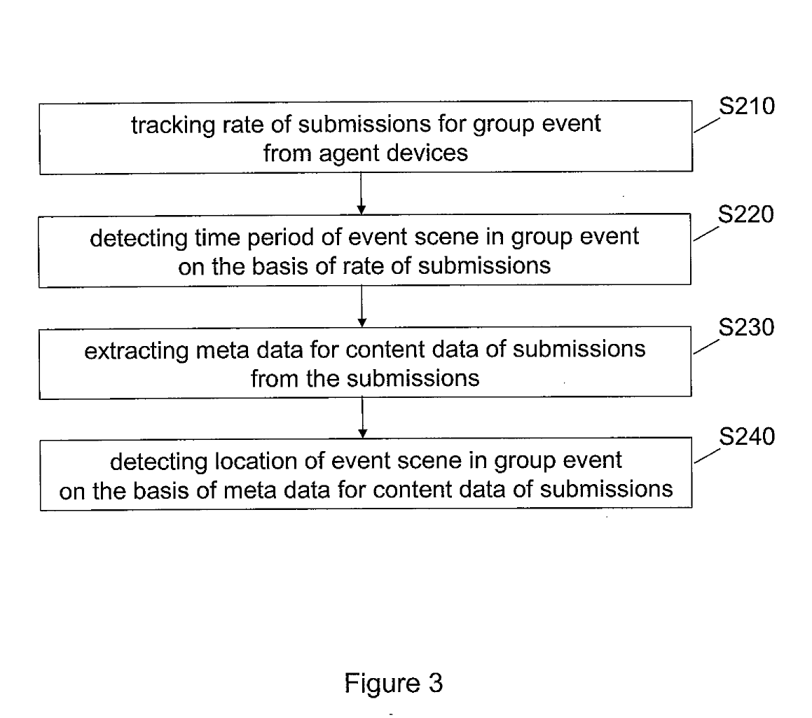

FIG. 3 shows a flowchart illustrating a second example of a method according to exemplifying embodiments of the present invention. The thus illustrated method may be operable at or by a server/central storage and/or a client device, as described in connection with FIG. 1.

As shown in FIG. 3, a method according to an exemplifying embodiment of the present invention comprises an operation (S210) of tracking a rate of submissions (i.e. a rate of submission uploads) for a group event from one or more agent devices of participants in the group event to a central storage, an operation (S220) of detecting a time period of the event scene in the group event on the basis of the tracked rate of submissions for the group event, an operation (S230) of extracting meta data relating at least to a location of the event scene in the group event from a submission on the basis of content data in the submission from an agent device, and an operation (S240) of detecting the location of the event scene in the group event on the basis of meta data of the submissions (i.e. meta data for the content data of the submissions). By way of the thus detected time period and location, the event scene may be recognized/identified (when still being in progress).

In the present example, it is assumed that a submission from an agent device includes only content data relating to an event scene in the group event, but no meta data for the content data of the submission. Hence, the meta data for the content data of a respective submission, which relate at least to a location of the event scene in the group event (to which the content data of the submission relate in question as well), is to be extracted, e.g. from Exif data of an image representing content data of the submission in question. In such case, no one or at least not all of the agent devices are enabled to and/or provide additional information on its provided content data (e.g. upon processing the same).

While the examples of methods according to exemplifying embodiments of the present invention are illustrated in separate flowcharts of FIGS. 2 and 3, it is noted that these methods may also be combined according to exemplifying embodiments of the present invention. That is, a server/central storage and/or a client device, which is operable to carry out such combined method, is able to detect the location of the event scene according to operation S130 for each submission including both content data and corresponding meta data, and may extract the meta data according to the operation S230 and detect the location of the event scene according to operation S240 for each submission including only content data. Thus, submissions from one or more agent devices, which are enabled to and provide additional information on its provided content data, and submissions from one or more agent devices, which are not enabled to and/or do to not provide additional information on its provided content data, can be handled (in a combined manner) at the same entity identifying a single event scene in group event.

Generally, the content data relating to the event scene in the group event may comprise one or more of an image of the event scene, a video of the event scene, and a message or text about the event scene (e.g. a tweet, an instant messaging text, etc.). Such content data is generated with/by the agent device accordingly. The meta data relating at least to a location of the event scene in the group event may comprise location-related information indicative of the location of the agent device when generating the content data, or location-related information indicative of the location of the agent device when generating the content data and distance-related information indicative of the distance between the agent device and the event scene when generating the content data. The location-related information may for example comprise GPS (Global Positioning System) coordinates or (absolute or relative) coordinates of any other positioning system. The distance-related information may for example comprise, or be extracted from, a distance-to-scene value such as the value in a subject distance field of Exif (Exchangeable Image File Format) data from a camera with which an image or video of associated content data is captured. In case the meta data does not contain any distance-related information, especially no distance-to-scene value, such distance-related information could be estimated (by any entity processing such data, e.g. the server or the client device) on the basis of a pattern recognition approach in consideration of a focal length (e.g. in the Exif data) of a camera with which an image or video of associated content data is captured, for example. The meta data may additionally relate to a time of the event scene in the group event, and may thus comprise time-related information indicative of the time when generating the content data.

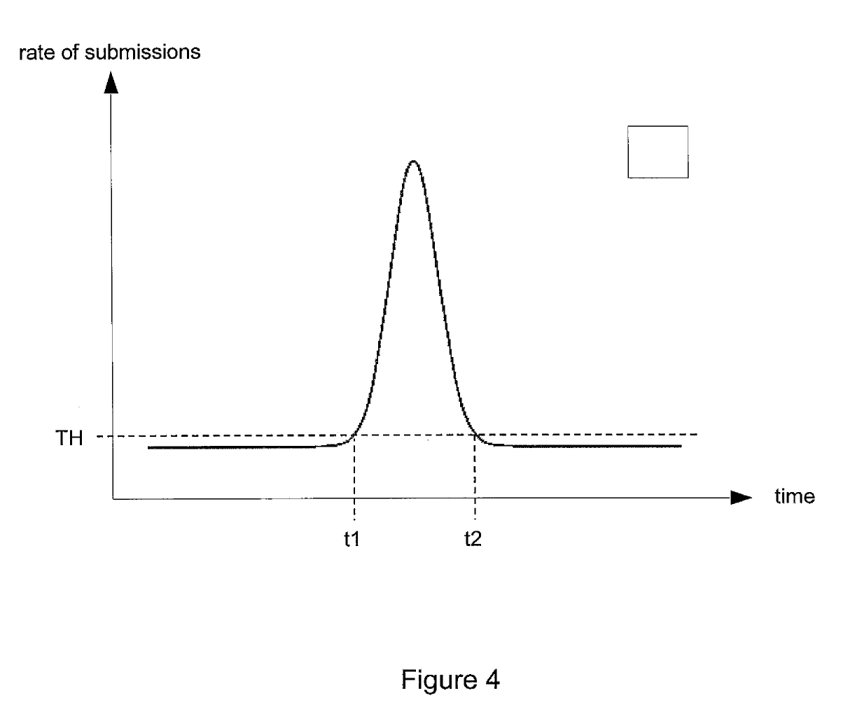

FIG. 4 shows a graph illustrating a curve of a rate of submissions for explaining the detection of a time period of an event scene according to exemplifying embodiments of the present invention.

As shown in FIG. 4, the number of submissions per unit time (e.g. the number of submissions per second), which represents a rate of submissions (submission rate) or a rate of submission uploads (upload rate), may be assumed to be relatively constant/flat, as long as no specifically interesting or important event scene occurs, to (significantly) increase during occurrence of a specifically interesting or important event scene, and to return to be relatively constant/flat after termination of such specifically interesting or important event scene (with similar values as before the event scene). In the illustrated example, it may be assumed that an event scene to be recognized/identified occurs from time t1 until time t2. Accordingly, the time period of the event scene is detected by way of the begin thereof (i.e. time t1) and the end thereof (i.e. time t2).

Although the curve of the rate of submissions is illustrated in FIG. 4 as a continuous line/plot, it may be composed of a sequence of time values of the rate of submission, i.e. a time series of values of the rate of submissions per (discrete) time instance. Such time values of the rate of submission may be derived from the uploaded submissions upon receipt thereof at the central storage and/or a client device.

According to exemplifying embodiments of the present invention, occurrence of an event scene to be recognized/identified, i.e. its time period, may be detected in any conceivable manner using the tracked rate of submissions for the group event. As an example, the time period of the event scene in the group event may be detected as a period of time in which the rate of submissions for the group event is equal to or larger than a predetermined submission rate threshold value. As exemplarily illustrated in FIG. 4, occurrence of an event scene to be recognized/identified, i.e. its time period, may be detected when (or, as long as) the rate of submissions exceeds the threshold value TH. As another example, the time period of the event scene in the group event may be detected as a period of time in which a gradient of a temporal change of the rate of submissions for the group event is equal to or larger than a predetermined gradient threshold value. Namely, instead of or in addition to the absolute value of the rate of submissions, the temporal increment thereof (represented by the inclination of the curve illustrated in FIG. 4) may be considered for detecting the time period of an event scene to be recognized/identified. Any one of such exemplary time period detection approaches may be arbitrary combined as well.

Accordingly, the client device C may be notified (or, the user of the client device C may be informed) of the time period (i.e. the begin and the end) of the event scene to be recognized/identified. The time period-directed notification of the client device C (or, the time period-directed information of the user of the client device C) may for example refer to outputting an indication of the begin of the time period on the client device (e.g. acoustically and/or visually), outputting an indication of the end of the time period on the client device (e.g. acoustically and/or visually), vibrating the client device during the time period, reproducing content data relating to the event scene on the client device during the time period (e.g. displaying an image or video or text), and/or flashing a light during the time period. For example, the indication of the time period of the event scene may be accomplished by the sending of a message (e.g. a SMS (Short Message Service) message, a MMS (Multimedia Message Service) message, an email message, or the like) with corresponding data. Namely, the notification may be accomplished by way of a message, command, instruction, indication referring to the intended kind/type of information, and the information may be accomplished by performing a corresponding action.

According to exemplifying embodiments of the present invention, the submissions to be considered in tracking the rate of submissions for the group event may be all submissions relating to the group event or only a subset thereof. More specifically, the submissions may be checked in terms of their respective association with the event scene to be recognized/identified in the group event on the basis of least one of the content data thereof and the meta data thereof, wherein the rate of submissions for the group event is tracked only for those submissions which are associated with the event scene in the group event. To this end, a specific event scene or certain properties of a (potentially) interesting, important or relevant event scene may be (pre-)configured by a user of the client device, e.g. at the central storage, e.g. in terms of kind/type, time, location, involved people of scene, incident or action, or the like. Based thereon, the association of a submission with a specific event scene may be determined when location-related information of the meta data match with the (pre-)configured location of the desired event scene, and/or when time-related information of the meta data match with the (pre-)configured time of the desired event scene, and/or when the image or video or, text or subject/title thereof or the like, as represented by the content data, match with the (pre-)configured kind/type, and so on.

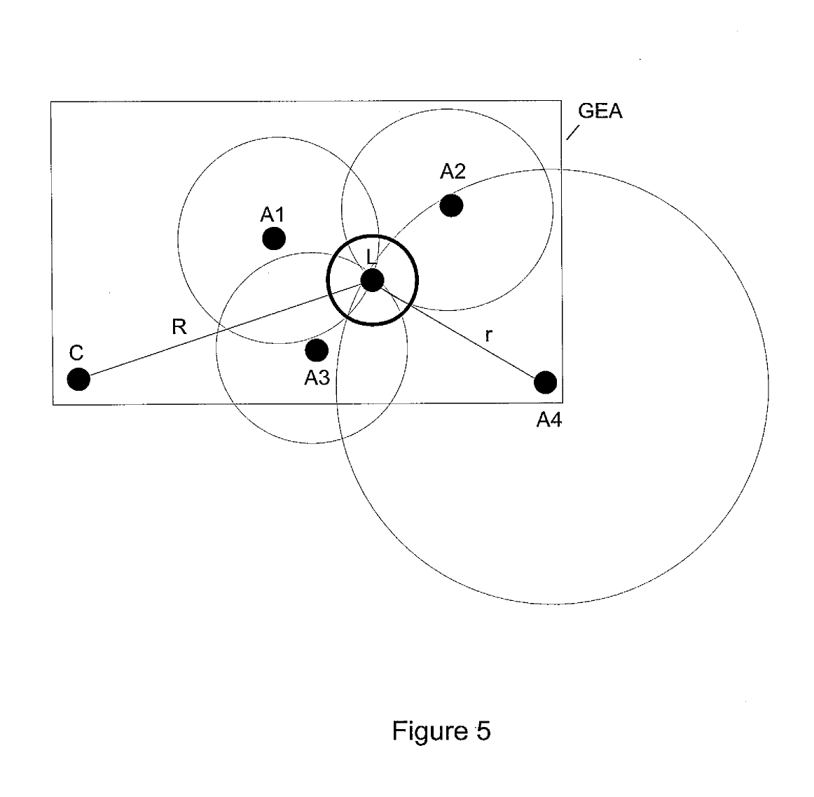

FIG. 5 shows a schematic diagram illustrating location-related relationships between various devices for explaining the detection of a location of an event scene according to exemplifying embodiments of the present invention.

As shown in FIG. 5, it is assumed that all of agent devices A1, A2, A3 and A4 and client device C are located within the group event area (GEA), as indicated by a square. Further, it is assumed that submissions from all of agent devices A1, A2, A3 and A4 are taken into consideration for identifying an event scene for the client device C, wherein any one of these submissions contains meta data including location-related information and distance-related information, as explained above. Namely, the dots denoted by A1, A2, A3 and A4 represent the thus indicated location, and the radii of the associated circles represent the thus indicated (or estimated) distance-to-scene, respectively.

According to exemplifying embodiments of the present invention, the location of the event scene in the group event may be detected by a triangulation-based approach using the location-related information or the location-related and distance-related information in the metadata of the submissions from the one or more agent devices. This is illustrated in FIG. 5, where the dot denoted by L represents an estimated/calculated location of the event scene, and the bold circle around this dot represents a potential estimation/calculation error.

Accordingly, the client device C may be notified (or, the user of the client device C may be informed) of the location of the event scene to be recognized/identified. Based on the location of the client device C, the distance-to-scene (denoted by R) and the direction-to-scene of the client device may be determined. The location-directed notification of the client device C (or, the location-directed information of the user of the client device C) may for example refer to outputting location-related information indicative of an absolute position of the event scene or relative position of the event scene with respect to the client device (e.g. acoustically or visually), reproducing an image of the location of the event scene, and/or reproducing a map indicating the location of the event scene (and, potentially, a route from the present location to the indicated location). An absolute position of the event scene could be represented by GPS coordinates or coordinates of any other position system. A relative position of the event scene with respect to the client device could be output by giving the information e.g. that “the scene occurred 100 steps to north from you” or the like. Namely, the notification may be accomplished by way of a message, command, instruction, indication referring to the intended kind/type of information, and the information may be accomplished by performing a corresponding action.

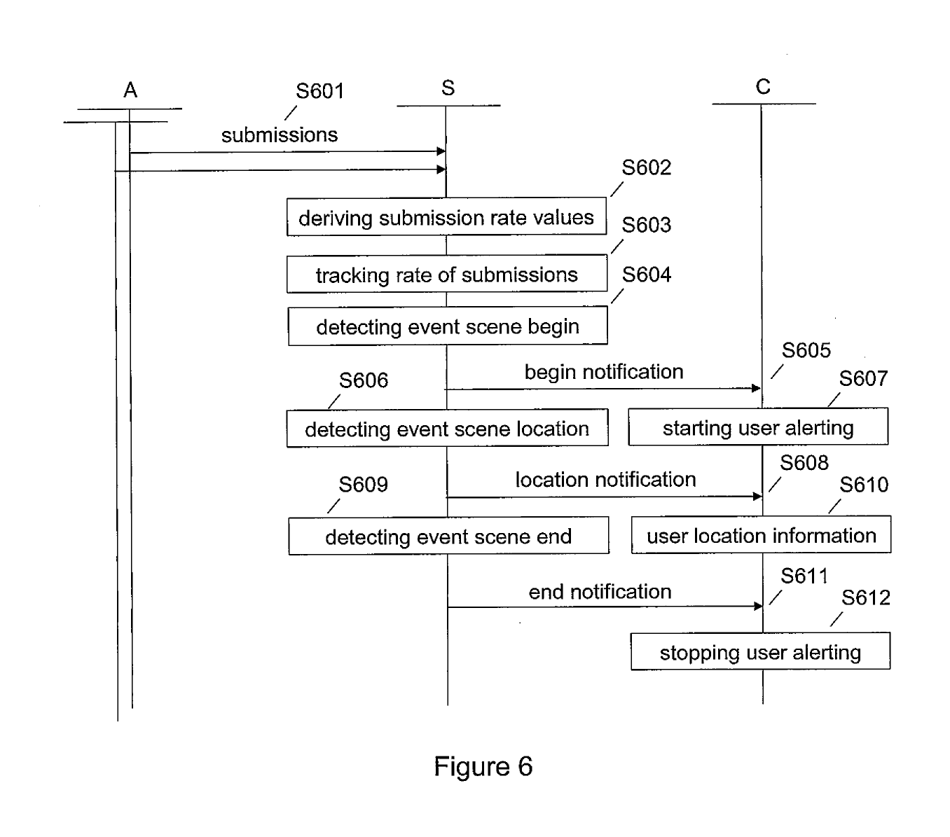

In the following, some exemplifying procedures of the present invention are described with reference to FIGS. 6 to 8. The illustrated procedures are exemplified by referring to two agent devices A, a server/central storage S and a client device C, as described in connection with FIG. 1, for illustrative purposes only. Further, it is exemplarily assumed, for illustrative purposes only, the submissions from the agent devices comprise both content data and corresponding meta data.

FIG. 6 shows a diagram illustrating a first example of a procedure according to exemplifying embodiments of the present invention.

In step S601, a number of submissions for the group event are uploaded from the agent devices A to the central storage S. At the central storage 5, the submissions from the agent devices are received, and the received submissions including their respective content data and meta data are stored. Then, the central storage S derives values of the rate of submissions for the group event per time instance (i.e. time values of the submission rate) on the basis of the received submissions for the group event (step S602), and tracks the rate of submissions for the group event on the basis of the derived time values (step S603). In step S604, the central storage S detects the begin of an event scene (e.g. t1 in FIG. 4), and notifies the detected begin time to the client device C accordingly in step S605. Such notification may be accomplished by a corresponding message, command, instruction, indication, as mentioned above. Upon such time period-directed notification from the central storage S, the client device C informs (or, stated in other words, alters) its user about the occurrence, i.e. the begin, of an event scene in step S607. In step S606, the central storage S detects the location of the event scene (e.g. L in FIG. 5), and notifies the detected location to the client device C accordingly in step S608. Such notification may be accomplished by a corresponding message, command, instruction, indication, as mentioned above. Upon such location-directed notification from the central storage 5, the client device C informs its user about the location of the event scene in step S610. In step S609, the central storage S detects the end of the event scene (e.g. t2 in FIG. 4), and notifies the detected end time to the client device C accordingly in step S611. Such notification may be accomplished by a corresponding message, command, instruction, indication, as mentioned above. Upon such time period-directed notification from the central storage S, the client device C informs (or, stated in other words, alters) its user about the termination, i.e. the end, of the event scene in step S612.

In the case that the submissions from at least some of the agent devices comprise only content data, the central storage S may extract the corresponding meta data for each one of such submissions before detecting the event scene location in step S606.

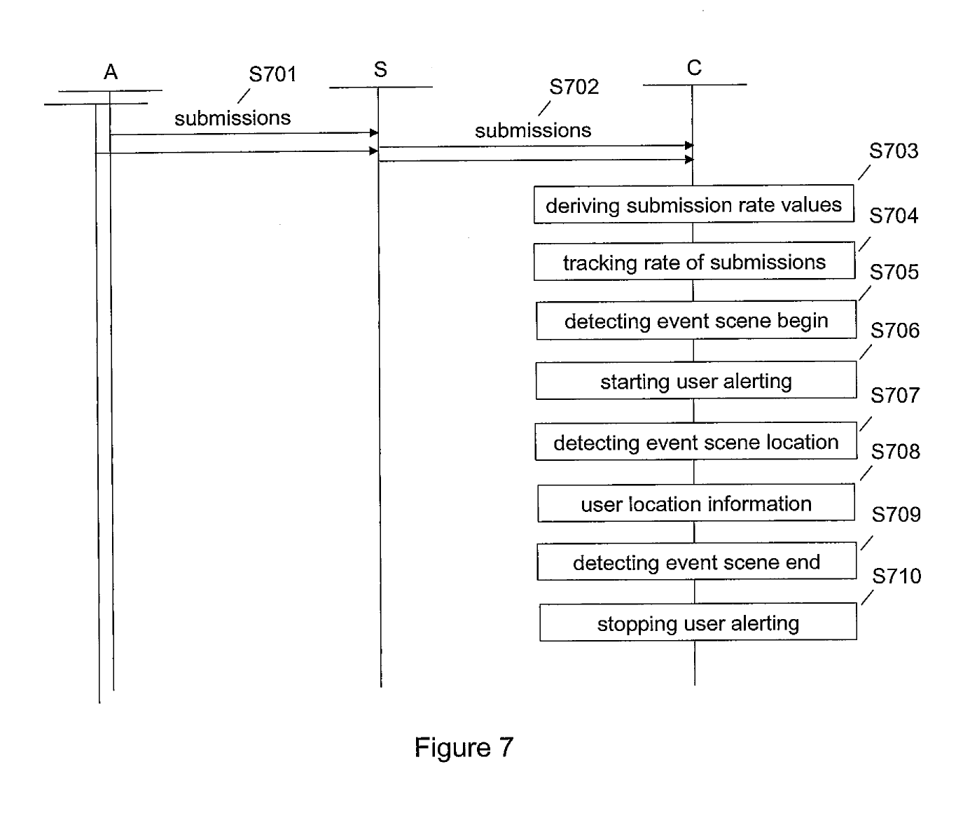

FIG. 7 shows a diagram illustrating a second example of a procedure according to exemplifying embodiments of the present invention.

In step S701, a number of submissions for the group event are uploaded from the agent devices A to the central storage S. In step S702, these submissions for the group event are forwarded from the central storage S to the client device C. Such forwarding may be accomplished on a periodical basis or by request/polling from the client device C, for example. At the client device C, the submissions from the agent devices are received, and the received submissions including their respective content data and meta data are stored. Then, the client device C derives values of the rate of submissions for the group event per time instance (i.e. time values of the submission rate) on the basis of the received submissions for the group event (step S703), and tracks the rate of submissions for the group event on the basis of the derived time values (step S704). In step S705, the client device C detects the begin of an event scene (e.g. t1 in FIG. 4), and informs (or, stated in other words, alters) its user about the occurrence, i.e. the begin, of an event scene in step S706. In step S707, the client device C detects the location of the event scene (e.g. L in FIG. 5), and informs its user about the location of the event scene in step S708. In step S709, the client device C detects the end of the event scene (e.g. t2 in FIG. 4), and informs (or, stated in other words, alters) its user about the termination, i.e. the end, of the event scene in step S710.

In the case that the submissions from at least some of the agent devices comprise only content data, the client device C may extract the corresponding meta data for each one of such submissions before detecting the event scene location in step S707.

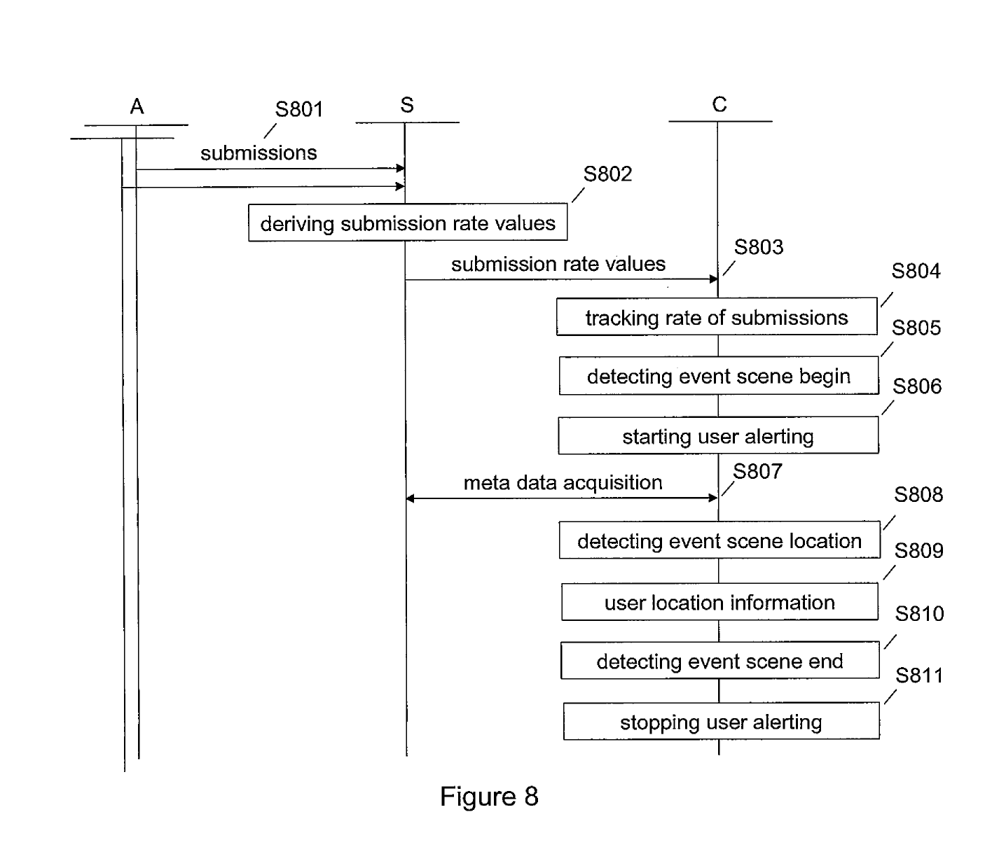

FIG. 8 shows a diagram illustrating a third example of a procedure according to exemplifying embodiments of the present invention.

In step S801, a number of submissions for the group event are uploaded from the agent devices A to the central storage S. At the central storage S, the submissions from the agent devices are received, and the received submissions including their respective content data and meta data are stored. Then, the central storage S derives values of the rate of submissions for the group event per time instance (i.e. time values of the submission rate) on the basis of the received submissions for the group event (step S802), and forwards the thus derived time values of the rate of submissions for the group event to the client device C (step S803). Such forwarding may be accomplished on a periodical basis or by request/polling from the client device C, for example. At the client device C, the time values of the rate of submissions for the group event are received and stored, and the rate of submissions for the group event is tracked on the basis of the received time values (step S804). In step S805, the client device C detects the begin of an event scene (e.g. t1 in FIG. 4), and informs (or, stated in other words, alters) its user about the occurrence, i.e. the begin, of an event scene in step S806. Upon detection of the begin of the time period of an event scene (i.e. when the rate of submissions for the group event increases), the client device C acquires (or, collects) at least the meta data of the submissions for the group event from the central storage S in step S807. Such meta data acquisition may comprise a request for meta data from the client device C to the central storage S, retrieval of the requested meta data from the stored submissions at the central storage S, and provision of the retrieved meta data in a response from the central storage S to the client device C. In step S808, the client device C detects the location of the event scene (e.g. L in FIG. 5), and informs its user about the location of the event scene in step S809. In step S810, the client device C detects the end of the event scene (e.g. t2 in FIG. 4), and informs (or, stated in other words, alters) its user about the termination, i.e. the end, of the event scene in step S811.

In the case that the submissions from at least some of the agent devices comprise only content data, the central storage S may extract the corresponding meta data for each one of such submissions upon the meta data acquisition by the client device C in step S807. Otherwise, within the context of the meta data acquisition by the client device C in step S807, the client device may request the central storage S for respective submission without meta data, the central storage S may forward the requested submissions without meta data to the client device C, and the client device C may itself extract the corresponding meta data for these submissions.

In view of the above, it is achieved with any one of the exemplary procedures of FIGS. 6 to 8 that the user of the client device C is alerted from the begin of an event scene until the end thereof, and is informed about the location of the event scene (potentially, as sort of preview, together with a (subset of) corresponding content data such as image/s, video/s, message/s, text/s thereof). Accordingly, the user of the client device C is made aware of an ongoing event scene, and he is thus enabled to evaluate interest, importance or relevance thereof and to still attend or join the same, if desired.

With reference to any one of FIGS. 6 to 8, it is noted that the illustrated sequence of the individual steps and operations is adopted as a non-limiting example only and may be varied in various way. For example, the location of the event scene may be detected even prior to or (virtually or partly) simultaneous with the begin notification or the user altering start, and/or the end of the event scene may be detected even prior to or (virtually or partly) simultaneous with the location notification or the user location information.

Referring to the exemplary procedure of FIG. 6, it is to be noted that a notification/information directed to the time period of an event scene may be provided (e.g. broadcast or multicast) to all devices, or all potential client devices (i.e. all devices of participants who have not made any submissions in this regard), in the group event area or within a specified distance to the event scene (when the location of the event scene is already detected at that time). Also, it is to be noted that a notification/information directed to the location of an event scene may be provided (e.g. broadcast or multicast) to all devices, or all potential client devices (i.e. all devices of participants who have not made any submissions in this regard), in the group event area or within a specified distance to the event scene.

By virtue of exemplifying embodiments of the present invention, as evident from the above, identification of a specific event scene in a group event is enabled by utilizing the submissions of participants of the group event to a content storing and sharing service with a central storage. More specifically, it is enabled to identify a specific event scene (while still being in progress) by detecting a time period and a location thereof. Stated in other words, it is enabled that interesting, important or relevant scenes of a group event, i.e. an event with multiple participants, is recognized and identified for one of the participants, thereby facilitating that this participant can attend or join (but does not inadvertently miss) a correspondingly recognized/identified scene.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, nodes and systems, including both software and/or hardware thereof.

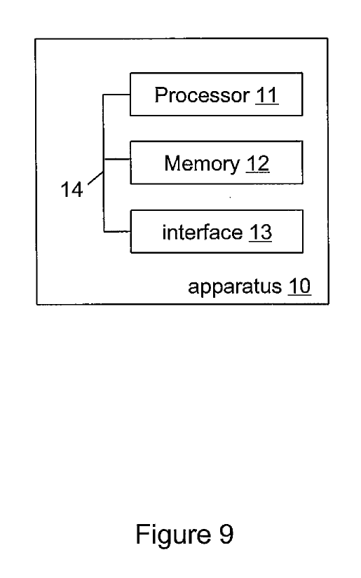

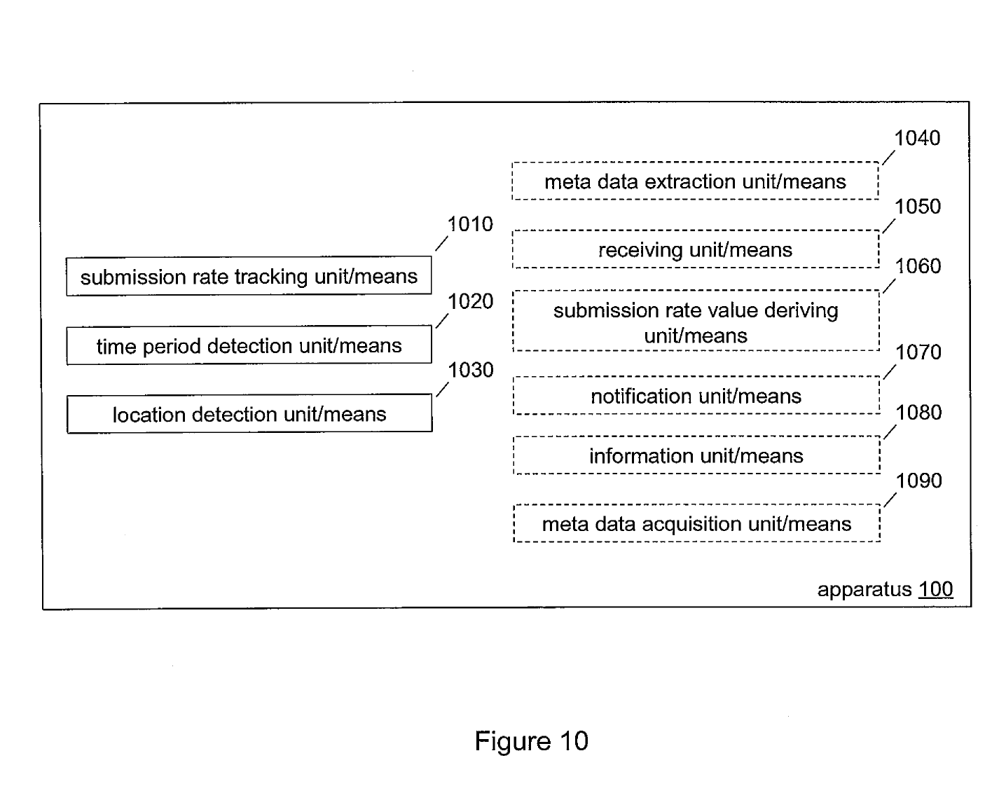

Respective exemplifying embodiments of the present invention are described below referring to FIGS. 9 and 10, while for the sake of brevity reference is made to the detailed description of respective corresponding configurations/setups, schemes, methods and functionality, principles and operations according to FIGS. 1 to 8.

In FIGS. 9 and 10, the solid line blocks are basically configured to perform respective methods, procedures and/or functions as described above. The entirety of solid line blocks are basically configured to perform the methods, procedures and/or functions as described above, respectively. With respect to FIGS. 9 and 10, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 9 and 10, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

In general terms, respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated devices/apparatuses are suitable for use in practicing one or more of the exemplifying embodiments of the present invention, as described herein.

FIG. 9 shows a schematic diagram illustrating an example of a structure of apparatuses according to exemplifying embodiments of the present invention.

As indicated in FIG. 9, an apparatus 10 according to exemplifying embodiments of the present invention may comprise at least one processor 11 and at least one memory 12 (and possibly also at least one interface 13), which may be operationally connected or coupled, for example by a bus 14 or the like, respectively.

The processor 11 of the apparatus 10 is configured to read and execute computer program code stored in the memory 12. The processor may be represented by a CPU (Central Processing Unit), a MPU (Micro Processor Unit), etc, or a combination thereof. The memory 12 of the apparatus 10 is configured to store computer program code, such as respective programs, computer/processor-executable instructions, macros or applets, etc. or parts of them. Such computer program code, when executed by the processor 11, enables the apparatus 10 to operate in accordance with exemplifying embodiments of the present invention. The memory 12 may be represented by a RAM (Random Access Memory), a ROM (Read Only Memory), a hard disk, a secondary storage device, etc., or a combination of two or more of theses. The interface 13 of the apparatus 10 is configured to interface with another apparatus and/or the user of the apparatus 10. That is, the interface 13 may represent a network interface (including e.g. a modem, an antenna, a transmitter, a receiver, a transceiver, or the like) and/or a user interface (such as a display, touch screen, keyboard, mouse, signal light, loudspeaker, or the like).

The apparatus 10 may represent a (part of a) central storage or server, which may comprise or be comprised in cloud computing equipment, or a client device, which may comprise or be comprised in desktop or mobile computing equipment, as described in connection with FIG. 1. The apparatus 10 may be configured to perform a procedure and/or exhibit a functionality as described (for the server or central storage and/or the client device) in any one of FIGS. 1 to 8.

The apparatus 10 or its processor 11 (possibly together with computer program code stored in the memory 12), in its most basic form, is configured to track a rate of submissions for a group event from one or more agent devices of participants in the group event to a central storage, the submission from an agent device including content data relating to an event scene in the group event, detect a time period of the event scene in the group event on the basis of the tracked rate of submissions for the group event, and detect the location of the event scene in the group event on the basis of meta data for the content data of the submissions, said meta data relating at least to a location of the event scene in the group event.

Further, depending on its implementation in view of the exemplary procedures of FIGS. 6 to 8, an apparatus 10 or its processor 11 (possibly together with computer program code stored in the memory 12) according to exemplifying embodiments of the present invention is configured to perform/effect one or more of
extracting the meta data relating at least to a location of the event scene in the group event from a submission on the basis of the content data in the submission from an agent device,
receiving submissions for the group event or receiving values of the rate of submissions for the group,
deriving values of the rate of submissions for the group event per time instance,
notifying a client device of the time period and location of the event scene in the group event,
informing a user of a client device of the time period and location of the event scene in the group event, and
acquiring at least meta data for the content data of the submissions for the group event.

Accordingly, any one of the above-described schemes, methods, procedures, principles and operations may be realized in a computer-implemented manner.

Any apparatus according to exemplifying embodiments of the present invention may be structured by comprising respective units or means for performing corresponding operations, procedures and/or functions. For example, such means may be implemented/realized on the basis of an apparatus structure, as exemplified in FIG. 9 above, i.e. by one or more processors 11, one or more memories 12, one or more interfaces 13, or any combination thereof.

FIG. 10 shows a schematic diagram illustrating another example of a structure of apparatuses according to exemplifying embodiments of the present invention.

As shown in FIG. 10, an apparatus 100 according to exemplifying embodiments of the present invention may comprise (at least) a unit or means for tracking a rate of submissions for a group event from one or more agent devices of participants in the group event to a central storage (denoted as submission rate tracking unit/means 1010), the submission from an agent device including content data relating to an event scene in the group event, a unit or means for detecting a time period of the event scene in the group event on the basis of the tracked rate of submissions for the group event (denoted as time period detection unit/means 1020), and a unit or means for detecting the location of the event scene in the group event on the basis of meta data for the content data of the submissions, said meta data relating at least to a location of the event scene in the group event (denoted as location detection unit/means 1030).

Further, depending on its implementation in view of the exemplary procedures of FIGS. 6 to 8, an apparatus 100 according to exemplifying embodiments of the present invention may comprise one or more of
a unit or means for extracting the meta data relating at least to a location of the event scene in the group event from a submission on the basis of the content data in the submission from an agent device (denoted as meta data extraction unit/means 1040),
a unit or means for receiving submissions for the group event or receiving values of the rate of submissions for the group event (denoted as receiving unit/means 1050),
a unit or means for deriving values of the rate of submissions for the group event per time instance (denoted as submission rate value deriving unit/means 1060),
a unit or means for notifying a client device of the time period and location of the event scene in the group event (denoted as notification unit/means 1070),
a unit or means for informing a user of a client device of the time period and location of the event scene in the group event (denoted as information unit/means 1080), and
a unit or means for acquiring at least meta data for the content data of the submissions for the group event (denoted as meta data acquisition unit/means 1090).

For further details regarding the operability/functionality of the individual apparatuses according to exemplifying embodiments of the present invention, reference is made to the above description in connection with any one of FIGS. 1 to 8, respectively.

According to exemplifying embodiments of the present invention, any one of the processor, the memory and the interface may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units, means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible or non-transitory medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling event scene identification in a group event, in particular in a content storing and sharing service with a central storage. Such measures could exemplarily comprise tracking a rate of submissions for a group event from one or more agent devices of participants in the group event to a central storage, the submission from an agent device including content data relating to an event scene in the group event, detecting a time period of the event scene in the group event on the basis of the tracked rate of submissions for the group event, and detecting the location of the event scene in the group event on the basis of meta data for the content data of the submissions, said meta data relating at least to a location of the event scene in the group event.

Even though the invention is described above with reference to the examples and exemplifying embodiments with reference to the accompanying drawings, it is to be understood that the present invention is not restricted thereto. Rather, it is apparent to those skilled in the art that the above description of examples and exemplifying embodiments is for illustrative purposes and is to be considered to be exemplary and non-limiting in all respects, and the present invention can be modified in many ways without departing from the scope of the inventive idea as disclosed herein.

1. A method, comprising
tracking a rate of submissions for a group event from one or more agent devices of participants in the group event to a central storage, the submission from an agent device including content data relating to an event scene in the group event,
detecting a time period of the event scene in the group event on the basis of the tracked rate of submissions for the group event, and
detecting the location of the event scene in the group event on the basis of meta data for the content data of the submissions, said meta data relating at least to a location of the event scene in the group event.

2. The method according to claim 1, wherein
the submission from an agent device includes the meta data relating at least to a location of the event scene in the group event.

3. The method according to claim 1, further comprising:
extracting the meta data relating at least to a location of the event scene in the group event from a submission on the basis of the content data in the submission from an agent device.

4. The method according to claim 1, further comprising
receiving the submissions for the group event from the one or more agent devices of participants in the group event,
deriving values of the rate of submissions for the group event per time instance on the basis of the received submission for the group event, and
notifying a client device of another participant in the group event of the detected time period and location of the event scene in the group event.

5. The method according to claim 4, wherein
the notifying of the time period comprises at least one of sending a message for outputting an indication of the begin of the time period on the client device, sending a message for outputting an indication of the end of the time period on the client device, sending a command for vibrating the client device during the time period, and sending a command for reproducing content data relating to the event scene on the client device during the time period, and/or
the notifying of the location comprises at least one of transmitting location-related information indicative of an absolute position of the event scene or relative position of the event scene with respect to the client device, transmitting an image of the location of the event scene, and transmitting a map indicating the location of the event scene.

6. The method according to claim 1, further comprising
receiving the submissions for the group event from the central storage,
deriving values of the rate of submissions for the group event per time instance on the basis of the received submission for the group event, and
informing a user of a client device, who is another participant in the group event, of the detected time period and location of the event scene in the group event.

7. The method according to claim 6, wherein
the informing of the time period comprises at least one of outputting an indication of the begin of the time period on the client device, outputting an indication of the end of the time period on the client device, vibrating the client device during the time period, and reproducing content data relating to the event scene on the client device during the time period, and/or
the informing of the location comprises at least one of outputting location-related information indicative of an absolute position of the event scene or relative position of the event scene with respect to the client device, reproducing an image of the location of the event scene, and reproducing a map indicating the location of the event scene.

8. The method according to claim 1, further comprising
receiving values of the rate of submissions for the group event per time instance from the central storage,
acquiring at least the meta data for the content data of the submissions for the group event from the central storage upon detection of the begin of the time period of the event scene, and
informing a user of a client device, who is another participant in the group event, of the detected time period and location of the event scene in the group event.

9. The method according to claim 8, wherein
the informing of the time period comprises at least one of outputting an indication of the begin of the time period on the client device, outputting an indication of the end of the time period on the client device, vibrating the client device during the time period, and reproducing content data relating to the event scene on the client device during the time period, and/or
the informing of the location comprises at least one of outputting location-related information indicative of an absolute position of the event scene or relative position of the event scene with respect to the client device, reproducing an image of the location of the event scene, and reproducing a map indicating the location of the event scene.

10. The method according to claim 1, further comprising
checking the submissions in terms of their respective association with the event scene in the group event on the basis of least one of the content data thereof and the meta data thereof,
wherein the rate of submissions for the group event is tracked only for those submissions which are associated with the event scene in the group event.

11. The method according to claim 1, wherein
the time period of the event scene in the group event is detected as a period of time in which the rate of submissions for the group event is equal to or larger than a predetermined submission rate threshold value and/or a gradient of a temporal change of the rate of submissions for the group event is equal to or larger than a predetermined gradient threshold value.

12. The method according to claim 1, wherein
the meta data for the content data of the submission comprises location-related information indicative of the location of the agent device when generating the content data, or location-related information indicative of the location of the agent device when generating the content data and distance-related information indicative of the distance between the agent device and the event scene when generating the content data, and
the location of the event scene in the group event is detected by a triangulation-based approach using the location-related information or the location-related and distance-related information of the meta data for the content data of the submissions from the one or more agent devices.

13. An apparatus, comprising
a memory configured to store computer program code, and
a processor configured to read and execute computer program code stored in the memory,
wherein the processor is configured to cause the apparatus to perform:
tracking a rate of submissions for a group event from one or more agent devices of participants in the group event to a central storage, the submission from an agent device including content data relating to an event scene in the group event,
detecting a time period of the event scene in the group event on the basis of the tracked rate of submissions for the group event, and
detecting the location of the event scene in the group event on the basis of meta data for the content data of the submissions, said meta data relating at least to a location of the event scene in the group event.

14. The apparatus according to claim 13, wherein
the submission from an agent device includes the meta data relating at least to a location of the event scene in the group event.

15. The apparatus according to claim 13, wherein the processor is configured to cause the apparatus to perform:
extracting the meta data relating at least to a location of the event scene in the group event from a submission on the basis of the content data in the submission from an agent device.

16. The apparatus according to claim 13, wherein the processor is configured to cause the apparatus to perform:
receiving the submissions for the group event from the one or more agent devices of participants in the group event,
deriving values of the rate of submissions for the group event per time instance on the basis of the received submission for the group event, and
notifying a client device of another participant in the group event of the detected time period and location of the event scene in the group event.

17. The apparatus according to claim 16, wherein
the notifying of the time period comprises at least one of sending a message for outputting an indication of the begin of the time period on the client device, sending a message for outputting an indication of the end of the time period on the client device, sending a command for vibrating the client device during the time period, and sending a command for reproducing content data relating to the event scene on the client device during the time period, and/or
the notifying of the location comprises at least one of transmitting location-related information indicative of an absolute position of the event scene or relative position of the event scene with respect to the client device, transmitting an image of the location of the event scene, and transmitting a map indicating the location of the event scene.

18. The apparatus according to claim 13, wherein the processor is configured to cause the apparatus to perform:
receiving the submissions for the group event from the central storage,
deriving values of the rate of submissions for the group event per time instance on the basis of the received submission for the group event, and
informing a user of a client device, who is another participant in the group event, of the detected time period and location of the event scene in the group event.

19. The apparatus according to claim 18, wherein
the informing of the time period comprises at least one of outputting an indication of the begin of the time period on the client device, outputting an indication of the end of the time period on the client device, vibrating the client device during the time period, and reproducing content data relating to the event scene on the client device during the time period, and/or
the informing of the location comprises at least one of outputting location-related information indicative of an absolute position of the event scene or relative position of the event scene with respect to the client device, reproducing an image of the location of the event scene, and reproducing a map indicating the location of the event scene.

20. The apparatus according to claim 13, wherein the processor is configured to cause the apparatus to perform:
receiving values of the rate of submissions for the group event per time instance from the central storage,
acquiring at least the meta data for the content data of the submissions for the group event from the central storage upon detection of the begin of the time period of the event scene, and
informing a user of a client device, who is another participant in the group event, of the detected time period and location of the event scene in the group event.

21. The apparatus according to claim 20, wherein
the informing of the time period comprises at least one of outputting an indication of the begin of the time period on the client device, outputting an indication of the end of the time period on the client device, vibrating the client device during the time period, and reproducing content data relating to the event scene on the client device during the time period, and/or
the informing of the location comprises at least one of outputting location-related information indicative of an absolute position of the event scene or relative position of the event scene with respect to the client device, reproducing an image of the location of the event scene, and reproducing a map indicating the location of the event scene.

22. The apparatus according to any one of claims 13, wherein the processor is configured to cause the apparatus to perform:
checking the submissions in terms of their respective association with the event scene in the group event on the basis of least one of the content data thereof and the meta data thereof,
wherein the rate of submissions for the group event is tracked only for those submissions which are associated with the event scene in the group event.

23. The apparatus according to any one of claims 13, wherein
the processor is configured to detect the time period of the event scene in the group event as a period of time in which the rate of submissions for the group event is equal to or larger than a predetermined submission rate threshold value and/or a gradient of a temporal change of the rate of submissions for the group event is equal to or larger than a predetermined gradient threshold value.

24. The apparatus according to any one of claims 13, wherein
the meta data for the content data of the submission comprises location-related information indicative of the location of the agent device when generating the content data, or location-related information indicative of the location of the agent device when generating the content data and distance-related information indicative of the distance between the agent device and the event scene when generating the content data, and
the processor is configured to detect the location of the event scene in the group event by a triangulation-based approach using the location-related information or the location-related and distance-related information of the meta data for the content data of the submissions from the one or more agent devices.

25. A computer program product comprising computer-executable computer program code which, when the computer program code is executed on a computer, is configured to cause the computer to carry out a method comprising
tracking a rate of submissions for a group event from one or more agent devices of participants in the group event to a central storage, the submission from an agent device including content data relating to an event scene in the group event,
detecting a time period of the event scene in the group event on the basis of the tracked rate of submissions for the group event, and
detecting the location of the event scene in the group event on the basis of meta data for the content data of the submissions, said meta data relating at least to a location of the event scene in the group event.
